(19) United States
(12) Patent Application Publication
(10) Pub. No.: US 2004/0032330 A1
(43) Pub. Date: Feb. 19, 2004

(54) Pharmacy transaction system and method

(75) Inventor: Mark S. Hoffman, Lawrenceville, GA (US)

Correspondence Address: PAUL W. MARTIN, LAW DEPARTMENT, WHQ-5E, 1700 S. PATTERSON BLVD., DAYTON, OH, 45479-0001, US

(73) Assignee: NCR Corporation

(21) Appl. No.: 10/218,815

(22) Filed: Aug. 14, 2002

(51) Int. Cl. G08B 13/14

(52) U.S. Cl. 340/572.1; 340/5.2; 235/375

(57) ABSTRACT

A pharmacy transaction system which identifies pharmacy items bearing radio frequency identification (RFID) labels. One form of the system includes an RFID label associated with a pharmacy item, a reader for reading the RFID label to obtain RFID label identification information, and a computer for determining prescription information associated with the RFID label identification information.

### BACKGROUND OF THE INVENTION

The present invention relates generally to inventory management and, more specifically, to a pharmacy transaction system and method is provided.

Radio frequency identification (RFID) technology provides an alternative to bar code reader technology for distinguishing and recording items for purchase. Some of the uses of RFID technology are disclosed in U.S. Pat. No. 6,019,394 assigned to the assignee of the present invention. This patent is hereby incorporated by reference.

Pharmacies seek improved methods of identifying, tracking, and filling prescriptions. Therefore, it would be desirable to provide an improved pharmacy transaction system and method. It would also be desirable to provide a pharmacy transaction system and method which uses RFID technology.

### SUMMARY OF THE INVENTION

In accordance with the teachings of the present invention, a pharmacy transaction system and method is provided.

One form of the system includes an RFID label associated with a pharmacy item, a reader for reading the RFID label to obtain RFID label identification information, and a computer for determining prescription information associated with the RFID label identification information.

It is accordingly an object of the present invention to provide a pharmacy transaction system and method.

It is another object of the present invention to track and fill prescriptions using a radio frequency identification (RFID) label as a prescription label or in addition to a printed prescription label.

### BRIEF DESCRIPTION OF THE DRAWINGS

Additional benefits and advantages of the present invention will become apparent to those skilled in the art to which this invention relates from the subsequent description of the preferred embodiments and the appended claims, taken in conjunction with the accompanying drawings, in which:

FIG. 1 is a block diagram of a pharmacy transaction system; and

FIG. 2 is a flow diagram illustrating the method of the present invention.

### DETAILED DESCRIPTION OF THE PREFERRED EMBODIMENT

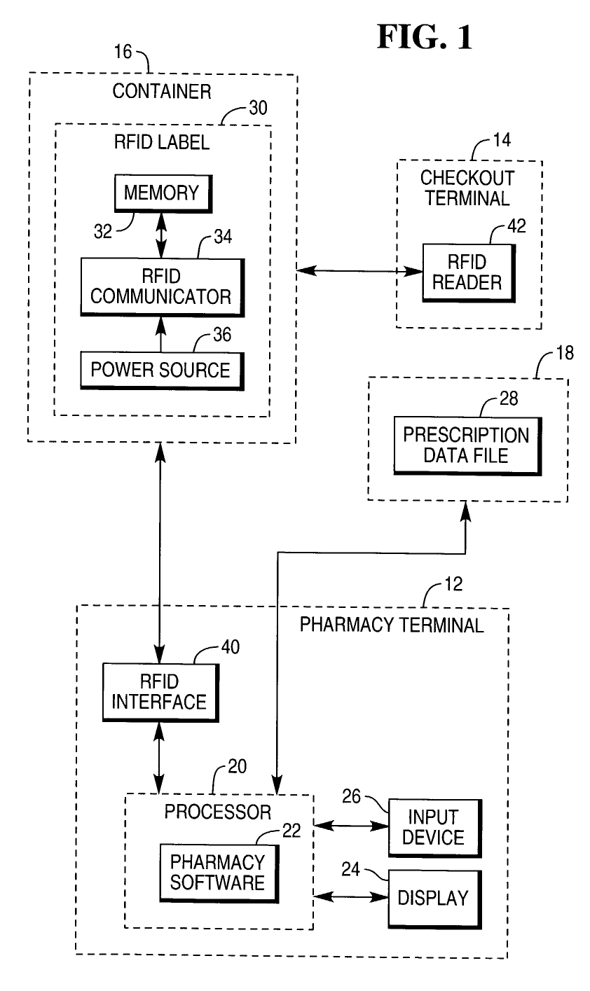

Referring now to FIG. 1, pharmacy transaction system 10 primarily includes pharmacy terminal 12 and checkout terminal 14.

Pharmacy terminal 12 includes processor 20 and radio frequency identification (RFID) interface 40.

Processor 20 executes pharmacy software 22. Pharmacy software 22 obtains prescription information for container 16 using RFID interface 40 and compares the prescription information to prescription information in prescription data file 28 to verify the information and to determine whether the prescription is refillable.

Prescription data file 28 may much information, including patient, physician, medicine, cost, dosage, issue time, and expiration information

Pharmacy software 22 also issues medicines based upon new prescriptions and stores new prescription information in prescription data file 28 using RFID interface 40.

Pharmacy terminal 12 additionally includes display 24 and input device 26 to allow the operator to enter and modify prescription information in prescription data file 28. Input device 26 may include a keyboard, mouse, touchpad, or a combination of these commonly used devices.

RFID interface 40 communicates with RFID label 30 on container 16. RFID interface 40 reads information from RFID label 30 and can be instructed to store information in RFID label 30 by pharmacy software 22.

RFID label 30 stores RFID label identification information and may additional store other information. RFID label 30 communicates stored information to RFID interface 40.

One embodiment of RFID label 18 is active and includes memory 32, RFID communicator 34, and power source 36. RFID communicator 34 sends information stored in RFID memory 32 to RFID interface 40. RFID communicator 34 may include an RF transceiver.

Memory 32 stores prescription and possibly other information, such as physician, pharmacist, FDA control codes, patient identification, cost, and fill date. Whatever information is not stored within memory 32 may be stored within other files, such as pharmacy data file 28. Memory 32 may also store an embedded agent or the like to preserve the privacy of the information. Memory 32 may include a read-only memory (ROM) for one-time use, or a programmable ROM (EPROM) for repeated use.

Power source 36 may include a battery.

In another embodiment, RFID label 30 is a passive label. Passive RFID labels use very little energy and may only include RFID communicator 34. Power may be derived from radio waves.

RFID communicator 34 may include a reflective antenna which has a frequency which is unique among different RFID labels 30. RFID communicator 34 communicates RFID label identification information which must be cross-referenced to obtain the prescription and other information. RFID communicator 34 may include a number of antennas, such as conductive ink antennas.

RFID label 30 may vary in size, depending upon container size, and may be visible or hidden when attached to containers 16. RFID label 30 may be removably or permanently attached to containers 16.

Checkout terminal 14

Storage medium 18 stores prescription data file 28.

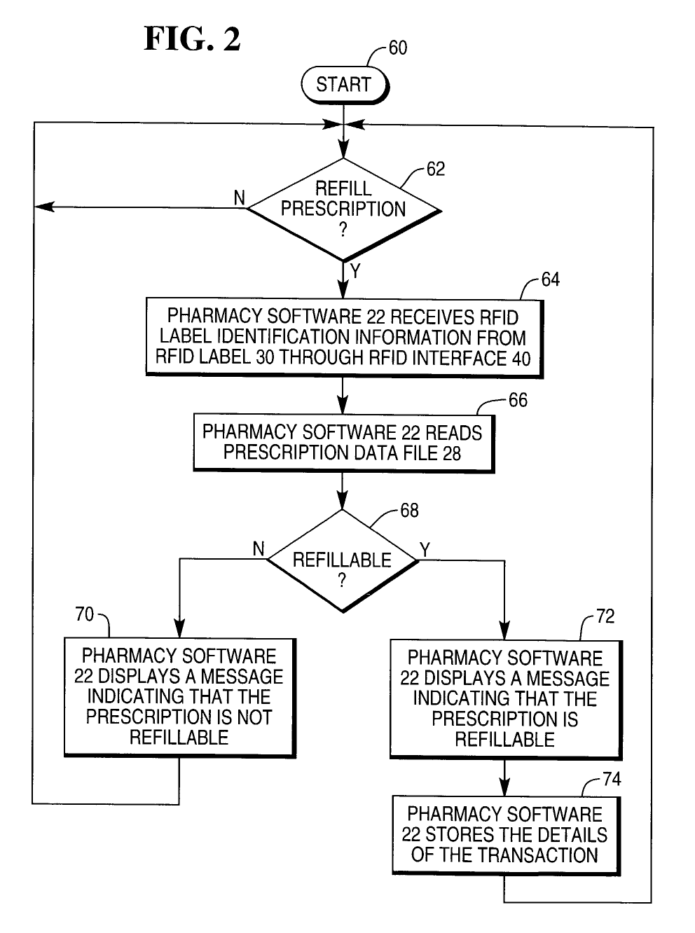

Turning now to FIG. 2, refill operation is illustrated in more detail beginning with START 60.

In step 62, pharmacy software 22 waits for an operator.

In step 64, pharmacy software 22 receives RFID label identification information from RFID label 30 through RFID interface 40.

In step 66, pharmacy software 22 reads prescription data file 28.

In step 68, pharmacy software 22 determines whether the prescription is refillable. If so, operation continues to step 72. Otherwise, operation proceeds to step 70.

In step 70, pharmacy software 22 displays a message indicating that the prescription is not refillable. Operation returns to step 62.

In step 72, pharmacy software 22 displays a message indicating that the prescription is refillable.

In step 74, pharmacy software 22 stores the details of the transaction in pharmacy data file 28 or may reprogram RFID label 30. Operation returns to step 62.

Pharmacy software 22 may issue medicine from new prescriptions. Pharmacy software 22 creates new records in prescription data file 28.

If pharmacy software 22 cannot find a record in prescription data file 28, pharmacy software 22 may create a new record if the prescription was not originally filled by pharmacy software 22.

During checkout, RFID reader 42 reads RFID label 30. Checkout terminal 14 may obtain cost information from RFID label 30, if it is stored there, from pharmacy data file 28, or from another file in use within the store. Checkout terminal 14 adds the cost to the transaction and completes the payment process.

Although the present invention has been described with particular reference to certain preferred embodiments thereof, variations and modifications of the present invention can be effected within the spirit and scope of the following claims.

I claim:

1. A method of completing a pharmacy transaction comprising the steps of:
receiving RFID label identification information from an RFID label associated with a pharmacy item; and
determining prescription information associated with the RFID label identification information.

2. The method as recited in claim 1, wherein the determining step comprises the substep of:
determining medicine information.

3. The method as recited in claim 1, wherein the determining step comprises the substep of:
determining patient information.

4. The method as recited in claim 1, wherein the determining step comprises the substep of:
determining physician information.

5. The method as recited in claim 1, wherein the determining step comprises the substep of:
determining cost information.

6. The method as recited in claim 1, wherein the determining step comprises the substep of:
determining dosage information.

7. The method as recited in claim 1, wherein the determining step comprises the substep of:
determining frequency information.

8. The method as recited in claim 1, wherein the determining step comprises the substep of:
determining issue time information.

9. The method as recited in claim 1, wherein the determining step comprises the substep of:
determining expiration information.

10. The method as recited in claim 1, further comprising the step of:
determining whether a prescription in the prescription information is refillable.

11. The method as recited in claim 10, further comprising the step of:
displaying a message indicating that the prescription is not refillable.

12. The method as recited in claim 10, further comprising the step of:
displaying a message indicating that the prescription is refillable.

13. The method as recited in claim 1, further comprising the step of:
recording purchase of a refill.

14. The method as recited in claim 13, further comprising the step of:
storing details of the purchase in a data file.

15. The method as recited in claim 13, further comprising the step of:
storing details of the purchase in the RFID label.

16. A method of completing a pharmacy transaction comprising the steps of:
receiving RFID label identification information from an RFID label associated with a pharmacy item;
determining prescription information associated with the RFID label identification information; and
determining whether a prescription in the prescription information is refillable.

17. A method of completing a pharmacy transaction comprising the steps of:
receiving RFID label identification information from an RFID label associated with a pharmacy item;
determining whether prescription information associated with the RFID label identification information is available; and
if the prescription information is not available, creating a record associating the RFID label identification information with a new prescription.

18. A method of completing a pharmacy transaction comprising the steps of:
establishing a record associating RFID label identification information of an RFID label with a prescription;
receiving the RFID label identification information from the RFID label;
determining prescription information from the record; and
determining whether a prescription in the prescription information is refillable from the record.

19. A pharmacy system comprising:
an RFID label associated with a pharmacy item;
a reader for reading the RFID label to obtain RFID label identification information; and
a computer for determining prescription information associated with the RFID label identification information.

20. A pharmacy system comprising:
an RFID label associated with a pharmacy item;
a reader for reading the RFID label to obtain RFID label identification information; and
a computer for determining prescription information associated with the RFID label identification information and for determining whether a prescription in the prescription information is refillable.
